(19) United States
(12) Patent Application Publication
(10) Pub. No.: US 2026/0200130 A1
(43) Pub. Date: Jul. 16, 2026

(54) METHOD FOR THE MANUFACTURE OF FORMWORK, LOST FORMWORK AND REINFORCEMENT FOR FREEFORM CONCRETE

(71) Applicants: Christoph Klemmt, Cincinnati, OH (US); Rajat Sodhi, New Delhi (IN)

(72) Inventors: Christoph Klemmt, Cincinnati, OH (US); Rajat Sodhi, New Delhi (IN)

(21) Appl. No.: 19/445,524

(22) Filed: Jan. 10, 2026

Related U.S. Application Data
(60) Provisional application No. 63/744,195, filed on Jan. 11, 2025.

(51) Int. Cl. B28B 7/00; B28B 1/14

(52) U.S. Cl. CPC B28B 7/0029; B28B 1/14

(57) ABSTRACT

The present invention is a method for the manufacture of freeform parts of molds, especially suitable for the casting of concrete. The method digitally tessellates the freeform surfaces of the mold into flat faces; the faces are grouped into segments, the segments are unrolled, are adjusted to incorporate connection details, and are cut from flat sheet material. When assembled, the panels take on the original freeform geometry by cold-bending. Additional support can be provided by a frame, and the mold can be filled with the casting material.

### TECHNICAL FIELD

The present invention relates to the casting of concrete, and specifically to the manufacture of molds and reinforcement with applications especially for freeform concrete geometries.

### BACKGROUND

Concrete is a widely used construction material due to its versatility and efficiency. However, the construction of freeform concrete geometries can be expensive, especially due to the costs of freeform molds or formwork. The often single-use molds or formwork required for this are expensive as they are often produced from Computer Numerical Control (CNC) milled foam or timber [1, 2]. Beyond aesthetic reasons for using freeform concrete, it is possible to use freeform geometries to reduce the material volume. Concrete applications have a large impact on the environment as cement is a major source of global warming [3]. It is possible to optimize geometries so that they consume lesser amounts of concrete while retaining their structural efficiencies. Through computational optimization, some researchers propose that it is possible to reduce up to 60% of concrete consumption in an element [4, 5, 6]. However, the production of such lightweight concrete elements requires geometrically complex formwork.

Several additive manufacturing technologies have been investigated for the fabrication of free-form concrete formwork in order to produce optimized components that utilize less cement. Binder Jet 3D Printing (BJP) of sandstone formwork was used for the production of a lightweight concrete slab, Smart Slab [5], a lightweight concrete truss [7], and the thin shell of the Swiss Pavilion at the Venice Biennale [8]. Fused deposition modeling (FDM) is another technology used for the production of formwork. Examples are flexible formwork [9], wax [10], and FDM for dissolvable formwork [11]. While 3D-printing methods offer geometric flexibility, detailed resolution and precision, the formwork itself is heavy and the fabrication process consumes a lot of energy. Other inexpensive freeform molds such as fabric formwork only allow very limited forms that may be unusable for optimized geometries [12].

The method that the present invention uses for the construction of molds has previously been used by the inventors and collaborators to construct freestanding surfaces as art projects, without their use as mold or formwork [13, 14]. Since their first use in 2008 [15], the method has been used by different artists and architects to create artistic surface structures [16,17].

U.S. Pat. No. 5,281,382A teaches the use of individual, flat, rigid panels to construct a mold. Patent US20110169828A1 teaches a method for approximating freeform geometry by developable strips, without their use as a mold. Molds that are folded from sheet material, with flat segments of panels between folds, that do not approximate a freeform surface, have been previously proposed [18].

### BRIEF SUMMARY

The present invention is a method for the manufacture of freeform molds, formwork, or lost formwork, by tessellating or triangulating the design geometry and manufacturing it from planar triangles or segments that can be cut from flat sheet material. The method comprises the following steps: The freeform part of the design geometry is digitally tessellated or triangulated; the resulting triangles are assigned to segments of at least one triangle; the segments are digitally unrolled to be planar; an offset to the outside, holes for assembly, and possibly numbering to be etched, are digitally added onto the unrolled geometry; the pieces are physically cut from flat sheet material; the cut pieces are assembled by fasteners, whereby the assembled pieces take on a three-dimensional geometry close to the design geometry of the formwork; the tessellated, freeform part of the formwork may be attached to other parts of the formwork, such as a flat base; a support structure may be attached to the formwork to provide additional support, especially to withstand the hydrostatic pressure of the casting material; the casting material is inserted into the formwork; and the formwork or parts of it may be removed after the hardening of the casting material. The method can be used to construct freeform objects, possibly from concrete, whereby the design can be aesthetically driven, or the design can follow optimized geometries that minimize the usage of the casting material.

### BRIEF DESCRIPTION OF THE DRAWINGS

FIG. 1 is an example of a freeform geometry to be cast in concrete.

FIG. 2 is a tessellation of the geometry of FIG. 1.

FIG. 3 are three unrolled segments of triangles based on the tessellation of FIG. 2.

FIG. 4 is a formwork to cast the geometry of FIG. 1, based on the tessellation of FIG. 2.

FIG. 5 is a formwork to cast the geometry of FIG. 1, based on the tessellation of FIG. 2.

FIG. 6 is a single-sided formwork to cast a dome, with concrete applied to part of it.

FIG. 7 is two panels attached by flanges.

FIG. 8 is formwork to cast a wall segment.

FIG. 9 is a section through concrete and formwork made from a polymer.

FIG. 10 is a section through concrete and lost formwork made from metal.

### DETAILED DESCRIPTION OF THE INVENTION

The present invention utilizes tessellated surfaces at least in part in the manufacture of freeform, removable formwork, lost formwork, or lost formwork that acts in part as the reinforcement of reinforced concrete. The double-curved part of the mold or formwork geometry is digitally, as in, by means of a computer, tessellated into flat faces, possibly by triangulating the curved surface. Those flat faces are assigned to segments of one or more faces and are digitally unrolled. Digitally, bolt holes are placed, possibly at the corners of the faces, and the unrolled segments are offset to the outside to fully surround the bolt holes and create an overlap of the segments in the assembled formwork. Those segments are then cut out of flat sheet material to form panels. The panels are then connected by bolts or other fasteners, whereby in this process they take on their intended geometry. A casting material, such as concrete, is then filled into the formwork.

In this document, the terms “formwork” and “mold” are used interchangeably, referring to the forms for casting of various materials.

In this document, the term “freeform” refers to geometry that comprises double-curved surface geometry.

In some embodiments of the present invention, the tessellation is carried out by means of a “meshing” algorithm, which exist in many computer programs for three-dimensional modelling.

In some embodiments of the present invention, the geometry is tessellated into triangles.

In some embodiments of the present invention, the geometry is tessellated into quadrangles. If this leads to quadrangles that are not planar, also the individual quadrangles are unrolled to be planar during the unrolling process.

In some embodiments of the present invention, the geometry is tessellated into hexagons. If this leads to hexagons that are not planar, also the individual hexagons are unrolled to be planar during the unrolling process.

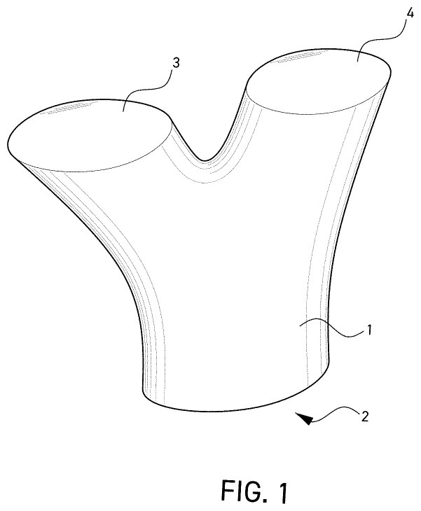

FIG. 1 is a possible freeform geometry to be manufactured with the formwork of the present invention. The solid volume is defined by its surfaces, consisting of one freeform surface 1, a planar bottom surface 2 underneath the volume, and two planar surfaces 3 and 4 at the top of the volume.

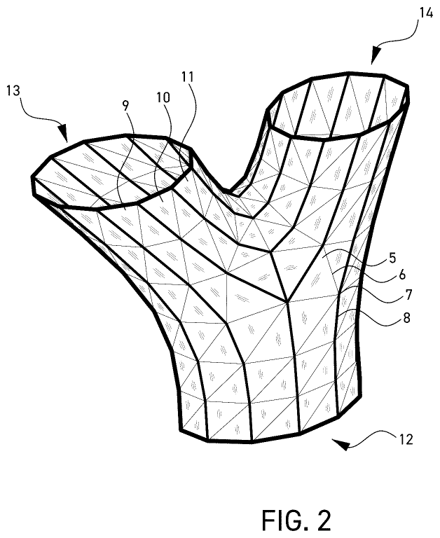

FIG. 2 shows the tessellation of the freeform surface 1 of FIG. 1 into triangular faces 5. The faces 5 are separated by edges 6, and defined by the vertices 7. FIG. 2 additionally shows the combination of the triangles into segments as indicated by the thicker lines 8, resulting in segments such as 9, 10, and 11. The planar surfaces 2, 3, and 4 of FIG. 1 are not tessellated and become the openings 12 underneath, and 13 and 14 on top of the geometry.

Segments are defined as unrollable groups of one or more faces. A single triangular face can be a segment. If a segment contains more than one face, all of the faces of the segment must be connected to the others by at least one shared edge; a connection between two faces at only one vertex is insufficient. For a segment to be unrollable, when unrolled, there are no overlaps of any faces of the same segment. To be unrollable, the segments have a width of no more than one face, so that within one segment, no vertex of any face is fully surrounded by faces of the same segment. Segments can be linear, whereby each face connects to two other faces, except for the two faces at either end of the segment that connect to only one other face. Segments can have a “Y” formation, whereby a central face connects to three other faces. Segments can have other arrangements as long as they remain unrollable.

Unrolling is the process of turning a three-dimensional geometry into planar geometry, so that the planar geometry can be turned back into the original three-dimensional geometry by folding or bending. In the case of triangles that have been combined into a segment, the unrolling can be achieved by an unfolding of the segment along each of the triangle edges that cross the segment, so that the two adjacent triangles are within the same plane and have the same normal direction, without a distortion of the triangle or a change in the length of any of its edges. To be unrollable also means that after unrolling, there is no overlap of any faces of the same segment.

In some embodiments of the present invention, at least three of the segments comprise at least three faces.

In some embodiments of the present invention, at least five of the segments comprise at least seven faces.

In some embodiments of the present invention, the panels are folded along the edges of the tessellation to turn them into their three-dimensional geometry.

In the preferred embodiments of the present invention, the panels are cold-bend to turn them into their three-dimensional geometry without any folding along the edges of the tessellation. A ductile material for the panels will make it easier for the panels to cold-bend and to form a continuous curvature across adjacent faces.

If the tessellation is too coarse and has few faces, the final cast is likely to deviate further from the intended design geometry. Also, fewer faces will make it more difficult to bend around a tight curvature without folding. If the tessellation is too fine, there will be many panels to assemble, which will increase the effort of the mold production.

In some embodiments of the present invention, adjacent panels have an overlap. In some embodiments of the present invention, adjacent panels are assembled with fasteners connecting through their shared overlap. Therefore, the unrolled segments are offset to the outside prior to cutting to create the overlapping areas with the adjacent panels, and bolt holes are placed within the overlapping areas. A compression joint connection across the overlapping area assists in creating a continuity of the curvature across adjacent faces.

In some embodiments of the present invention, bolt holes are placed at the vertices of the tessellated geometry.

In some embodiments of the present invention, bolt holes are placed centrally on the edges between two vertices of the tessellated geometry.

In some embodiments of the present invention, numbers or other information to identify panels or their position within the overall assembly are placed on each panel, possibly by engraving.

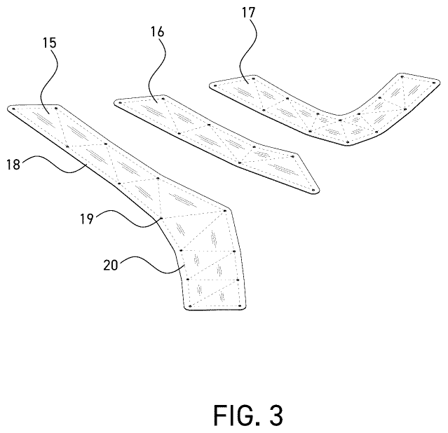

FIG. 3 is an axonometric that shows three panels 15, 16, and 17, that have been unrolled from three of the segments of FIG. 2, offset to the outside to create an overlap 18 between adjacent panels, with bolt holes 19 at the vertices of the tessellated geometry, cut out of a flat sheet material. The original triangulation of FIG. 2 is shown as broken lines 20. Panel 15 of FIG. 3 corresponds to segment 9 of FIG. 2; panel 16 of FIG. 3 corresponds to segment 10 of FIG. 2; and panel 17 of FIG. 3 corresponds to segment 11 of FIG. 2. In some embodiments of the present invention, the cutting of the panels is achieved by Computer Numerical Control cutting.

When the panels are attached to each other with fasteners, such as bolts or rivets, at the locations predefined by the precisely positioned holes, the panels bend and take on a three-dimensional geometry that is close to the design geometry. The sheet material thickness must be thin enough to allow for the bending of the panels. Double-curvature of the design geometry will increase the stiffness of the assembled panels.

If the formwork comprises partly freeform geometry and partly more regular geometry, such as planar surfaces, the panels that make up the freeform part of the formwork are attached to the more regular part of the formwork. This can be done by brackets and fasteners.

In some embodiments of the present invention, a sealant is used to close any gaps between or around the panels through which the casting material could seep during casting.

In some embodiments of the present invention, reinforcement, embeds, or other elements that are to be embedded in the final cast, are positioned within the formwork.

In many cases, a thickness that allows for a bending of the panels will make the assembled panels strong enough to stand up, but not strong enough to withstand the hydrostatic pressure of the casting material. Without sufficient additional support, the hydrostatic pressure of the casting material can cause significant deformations to the formwork.

In some embodiments of the present invention, the freeform part of the formwork is supported by a frame. In some embodiments of the present invention, this frame is attached to the open edges of the freeform part of the formwork. In some embodiments of the present invention, the frame is attached to locations on the freeform part of the formwork that are on the surface but not on its open edges. In some embodiments of the present invention, the frame is attached to some of the bolts that connect the panels of the freeform part of the mold. In some embodiments of the present invention, the frame is attached to all of the bolts that connect the panels of the freeform part of the mold. In some embodiments of the present invention, eye nuts that are attached to the end of the bolts that connect the panels of the freeform part of the mold, are used to connect the bolts to the frame. In some embodiments of the present invention, the frame is made from timber. In some embodiments of the present invention, the frame is made from metal. In some embodiments of the present invention, the frame is made from metal pipes.

In some embodiments of the present invention, the inside of the panels and bolts is treated to separate easily from the casting material after curing, such as by applying a mold release agent.

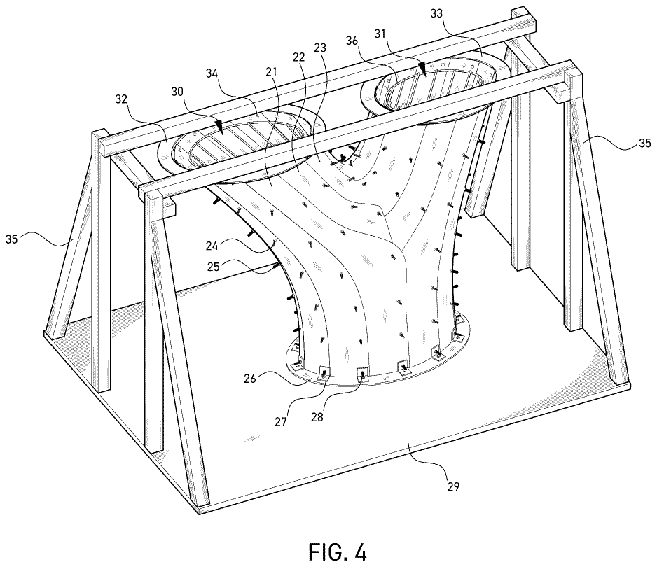

FIG. 4 is a formwork for the casting of the design geometry of FIG. 1, using the tessellation of FIG. 2. The panels, such as 21, 22, or 23, are overlapping with their adjacent panels. Panel 21 corresponds to Panel 15 of FIG. 3, and to segment 9 of FIG. 2; panel 22 corresponds to panel 16 of FIG. 3, and to segment 10 of FIG. 2; and panel 23 corresponds to panel 17 of FIG. 3, and to segment 11 of FIG. 2. They are connected by bolts, such as 24 or 25, that are placed at the locations of the vertices 7 of the tessellation of FIG. 2. The open end of the assembled panels at the bottom is attached to a steel ring 26 by brackets 27 and bolts 28. This steel ring is attached to a timber base plate 29. The openings 30 and 31 of the assembled panels at the top are attached to two steel rings 32 and 33, respectively, by brackets underneath the steel rings 32 and 33 not visible in this view, and bolts 34. A timber frame 35 is attached to the base 29 and to the steel rings 32 and 33 at the top of the assembled panels. Steel reinforcement 36 is positioned on the inside of the formwork.

Upon completion of the formwork of FIG. 4, concrete is inserted into the formwork through the openings 30 and 31. Upon curing of the concrete, the formwork can be disassembled and reused for a further cast.

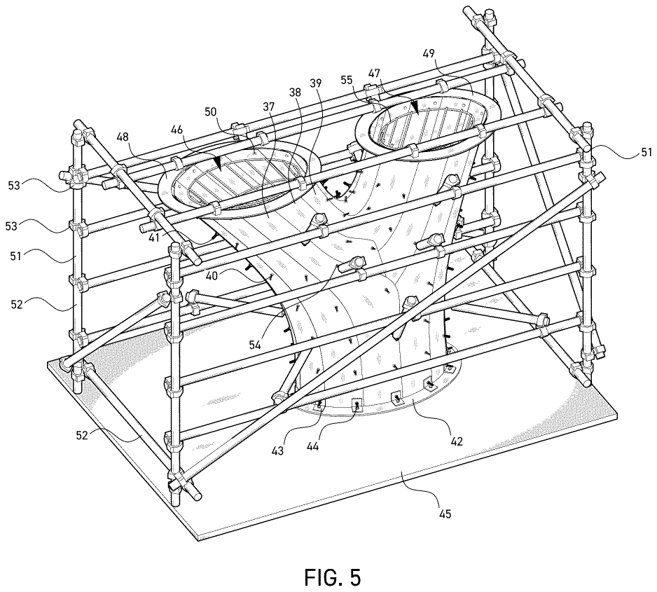

FIG. 5 is a formwork for the casting of the design geometry of FIG. 1, using the tessellation of FIG. 2. The panels, such as 37, 38, or 39, are overlapping with their adjacent panels. Panel 37 corresponds to Panel 15 of FIG. 3, and to segment 9 of FIG. 2; panel 38 corresponds to panel 16 of FIG. 3, and to segment 10 of FIG. 2; and panel 39 corresponds to panel 17 of FIG. 3, and to segment 11 of FIG. 2. They are connected by bolts, such as 40 or 41, that are placed at the locations of the vertices 7 of the tessellation of FIG. 2. The open end of the assembled panels at the bottom is attached to a steel ring 42 by brackets 43 and bolts 44. This steel ring is attached to a timber base plate 45. The openings 46 and 47 of the assembled panels at the top are attached to two steel rings 48 and 49, respectively, by brackets underneath the steel rings 48 and 49 not visible in this view, and bolts 50. A frame 51, made from steel pipes 52 and connectors 53, is attached to the base 45 and to the steel rings 48 and 49 at the top of the assembled panels. The frame 51 is further attached to selected bolts 54 across the freeform part of the formwork. Steel reinforcement 55 is positioned on the inside of the formwork.

Upon completion of the formwork of FIG. 5, concrete is inserted into the formwork through the openings 46 and 47. Upon curing of the concrete, the formwork can be disassembled and reused for a further cast.

In order to reduce the hydrostatic pressure that acts on the formwork, in some embodiments of the present invention, the casting material is inserted into the formwork in layers, whereby each layer of casting material is left to cure partly, or fully, before the next layer of casting material is inserted into the formwork.

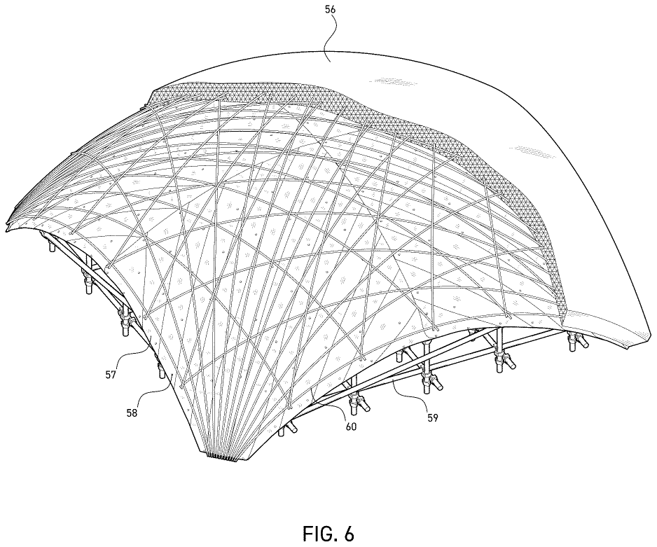

FIG. 6 is a single-sided formwork for casting a dome, in this figure partly covered in concrete 56. The panels 57 are connected by bolts 58. A frame 59 is positioned underneath the panels to provide additional support. Steel reinforcement 60 is placed above the panels. The concrete 56 is applied onto the formwork by means of troweling or shotcrete.

In some embodiments of the present invention, the panels that make up the freeform part of the formwork are made from polymers.

In the preferred embodiment of the present invention, the panels that make up the freeform part of the formwork are made from polypropylene.

In some embodiments of the present invention, instead of bolts through the overlap of adjacent panels, the panels are connected by flanges around the outer edges of each segment, the flanges folded approximately orthogonal to the design surface. Flanges of adjacent panels butt up against each other and are connected by fasteners.

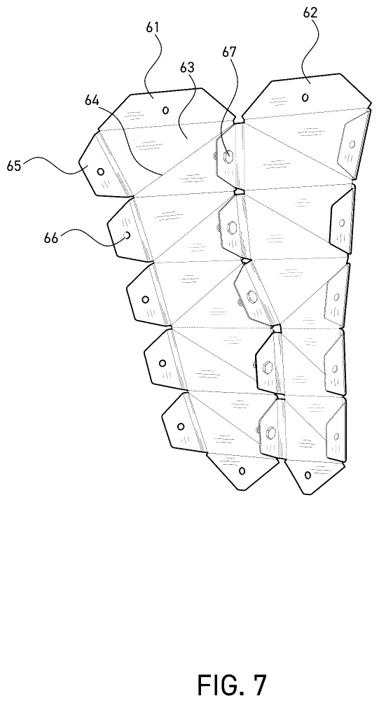

FIG. 7 shows two panels 61 and 62 that are connected by flanges. The triangles 63 within each panel are folded along the inner edges 64. Flanges 65 are attached to the outer edges of the panel and folded approximately orthogonal to the main panel surface. Holes 66 in the flanges allow the connection of adjacent panels by bolts 67 where two flanges of adjacent panels butt up against each other.

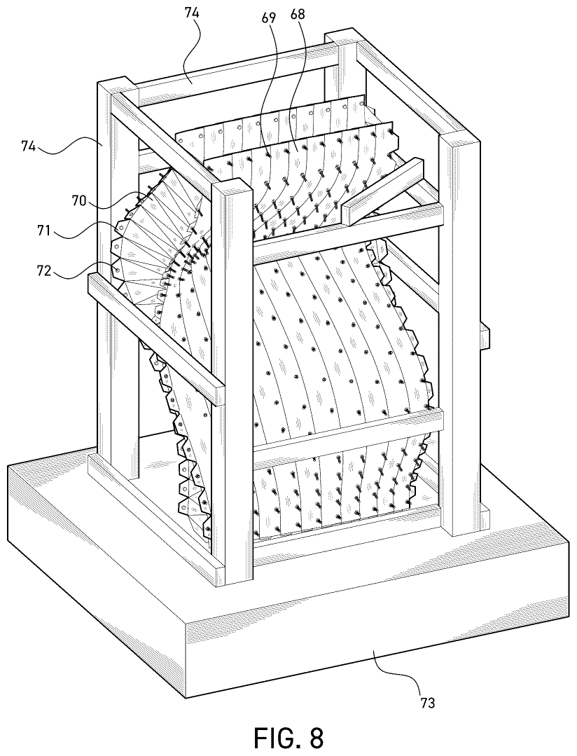

FIG. 8 shows a formwork to cast a wall element. The main panels 68 are connected to each other with bolts 69. The sides of the formwork are closed with side panels 70 that are triangulated. The side panels 70 have flanges 71 that are connected to the main panels 68 by bolts 72. The panels are positioned on a base 73, and are additionally supported by a timber frame 74 to hold the panels in place during the casting.

In the preferred embodiment of the present invention, adjacent panels are connected by bolts through an overlap along their edges. In the preferred embodiment of the present invention, the bolts are placed along the tessellated edges centrally between two vertices of the tessellation.

In the preferred embodiment of the present invention, the formwork is supported by a timber frame.

In the preferred embodiment of the present invention, the formwork is removed after the curing of the cast.

The panel edges and bolt heads will leave a texture on the surface of the cast object.

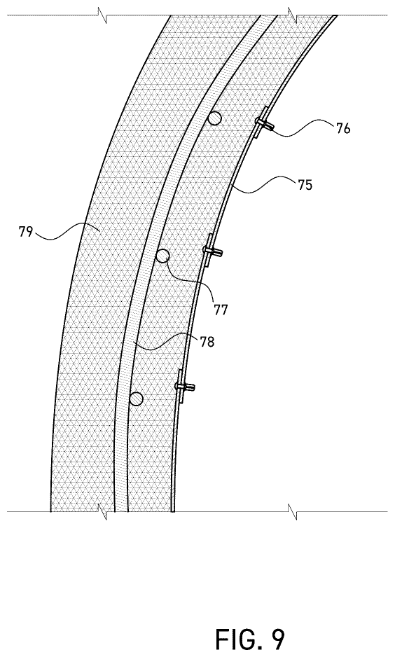

FIG. 9 is a section through the formwork and concrete using polymer panels. The panels 75, made from a polymer, are attached to each other by plastic rivets 76. Horizontal steel reinforcement 77 and vertical steel reinforcement 78 are placed within the concrete 79. In this example, the concrete could be applied by means of shotcrete.

In some embodiments of the present invention, the panels that make up the freeform part of the formwork are made from metal.

In some embodiments of the present invention, the panels that make up the freeform part of the formwork are made from steel or stainless steel.

In some embodiments of the present invention, the panels made from steel or stainless steel are used as lost formwork. The fasteners that connect the panels are protruding into the inside of the mold and thereby act as shear bolts that connect the casting material to the lost formwork.

In some embodiments of the present invention, the lost formwork is used as reinforcement of the concrete structure. The tensile forces in concrete, which are usually taken by traditional steel reinforcement, often occur at the bottom or the outside of the concrete volume. This is the location where the tessellated surface is positioned, that, in these embodiments, can withstand some, or all, of the tensile forces.

In some embodiments of the present invention, whereby the panels are lost formwork, the fasteners, protruding into the molds, are designed with a head inside the concrete, that improves the anchoring of the fastener in the concrete.

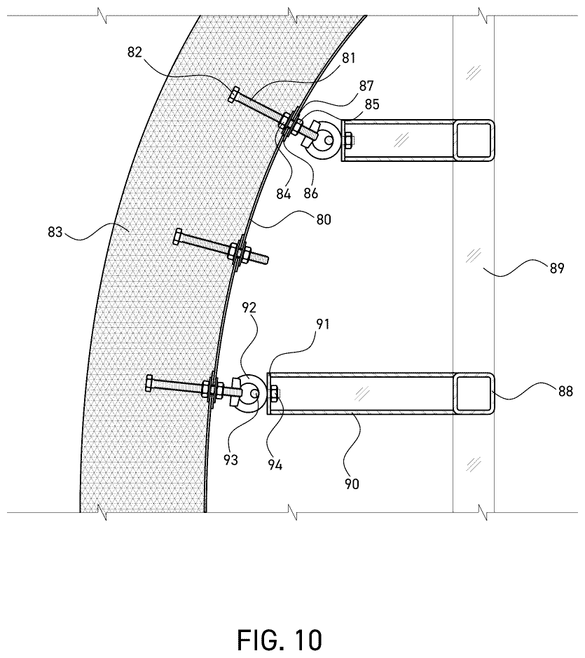

FIG. 10 is a section through the formwork and concrete using a lost metal formwork. The panels 80, made from steel or stainless steel, are attached to each other by bolts 81, wherein the bolt heads 82 are placed within the concrete 83. Adjacent panels are pressed together at the bolts by nuts 84 and 85 and washers 86 and 87. A steel frame 88, with its frame parts 89 shown in elevation, has steel connectors 90 attached to it, which are capped with steel plates 91. Selected bolts have eye nuts 92 attached to their ends, which are attached to the connectors 90 by U-bolts 93 and nuts 94. In this example, the concrete could be applied by means of shotcrete.

In some embodiments of the present invention, whereby the panels are lost formwork, the fasteners that connect the tessellated strips are eye bolts, with the eye positioned within the concrete.

In some embodiments of the present invention, whereby the panels are lost formwork, the bolts or fasteners that connect the tessellated strips are eye bolts, with the eye positioned within the concrete, with additional reinforcement bars placed to pass through the eyes of the eye bolts.

The present invention can be used for the casting of other materials than concrete.

The present invention can be used for the manufacturing of a positive geometry that is used to create a mold for casting.

In some embodiments of the present invention, the maximum curvature of the design surface is above 100,000 mm.

In some embodiments of the present invention, the maximum curvature of the design surface is between 10,000 mm and 100,000 mm.

In some embodiments of the present invention, the maximum curvature of the design surface is between 1,000 mm and 10,000 mm.

In some embodiments of the present invention, the maximum curvature of the design surface is between 100 mm and 1,000 mm.

In some embodiments of the present invention, the maximum curvature of the design surface is between 10 mm and 100 mm.

In some embodiments of the present invention, the maximum angle between adjacent faces of the tessellation is 45 degree.

In some embodiments of the present invention, the maximum angle between adjacent faces of the tessellation is 30 degree.

In some embodiments of the present invention, the maximum angle between adjacent faces of the tessellation is 15 degree.

In some embodiments of the present invention, the maximum angle between adjacent faces of the tessellation is 5 degree.

### REFERENCES CITED

1. Kolarevic, B. Digital Fabrication: Manufacturing Architecture in the Information Age. ACADIA (2001)
2. Kim, Keunho, Kiyoung Son, E-Doo Kim, and Sunkuk Kim. “Current trends and future directions of free-form building technology.” Architectural Science Review 58, no. 3 (2015): 230-243.
3. Lehne J. ; Preston F Making Concrete Change: Innovation in Low-carbon Cement and Concrete Executive Eummary of Chatham House Report CH, Switzerland (2018).
4. Aghaei Meibodi, M; Bernhard, M; Jipa, A; Dillenburger, B The Smart Takes from the Strong. In Fabricate 2017: Rethinking Design and Construction Eds. Menges, A; Sheil, B; Glynn, R; Skavara, M 210-17 UCL Press, London (2017).
5. Aghaei Meibodi, M; Jipa, A; Giesecke, R; Shammas, D; Bernhard, M; Leschok, M; Graser, K; Dillenburger, B Smart Slab: Computational Design and Digital Fabrication of a Lightweight Concrete Slab. In ACADIA 2018: Recalibration. On Imprecision and Infidelity. Proceedings of the 38th Annual Conference of the Association for Computer Aided Design in Architecture Eds. Anzalone, P; Del Signore, M; Wit, A J 434-443ACADIA, Mexico City, Mexico (2018).
6. Jipa, A; Bernhard, M; Dillenburger, B; Aghaei Meibodi, M 3D-Printed Stay-in-Place Formwork for Topologically Optimized Concrete Slabs. In 2016 TxA Emerging Design+Technology Ed. Bieg, K 96-107. San Antonio, TX (2016).
7. Morel, P Sand Molds for Ultra-High Performance Concrete Architecture trade fair in FRAC, Centre in Orléans (2014).
8. Dillenburger, B. Maschinelle Übersetzungen. Tec21, no 23 33rd International Symposium on Automation and Robotics in Construction 24-28 (2016).
9. Peters, B Additive Formwork: 3D Printed Flexible Formwork. In ACADIA 2014: Design Agency. Proceedings of the 34th Annual Conference of the Association for Computer Aided Design in Architecture Eds. Gerber, D; Huang, A; Sanchez, J 517-522 Riverside Architectural Press, Los Angeles (2014)
10. Gardiner, J B; Janssen, S; Kirchne, N A Realisation of a Construction Scale Robotic System for 3D Printing of Complex Formwork. 33rd International Symposium on Automation and Robotics in Construction. Auburn University (2016). http://www.iaarc.org/publications/fulltext/ISARC2016-Paper095.pdf
11. Aghaei Meibodi M; Kladeftira M; Kyttas T; Dillenburger B Bespoke Cast Facade, Design and Additive Manufacturing for Aluminum Facade Elements. In Acadia 2019: Ubiquity And Autonomy. Proceedings of the 39th Annual Conference of the Association for Computer Aided Design in Architecture Eds Bieg, K; Briscoe, D; Odom, C 100-109 ACADIA, Austin, TX (2019)
12. Orr, J., Darby, A. P., Ibell, T., Evernden, M. C. and Otlet, M., 2011. Concrete structures using fabric formwork.
13. Klemmt C, Sugihara S. Growth Structures. In 2016 TxA Emerging Design+Technology Conference Proceedings; 2018. p. 108-123.
14. Klemmt C. Curved Space as a Design Tool to Control the Growth of Venation and Shortest Path Algorithms. In Estévez A T, editor. 3rd International Conference of BioDigital Architecture & Genetics; 2017. p. 122-133.
15. Fairs, Marcus. 2008. “Project Or in Milan.” Dezeen, Apr. 18, 2008. https://www.dezeen.com/2008/04/18/project-or-by-christoph-klemmt/.
16. Fornes, Marc. 2015. “Nonlin/Lin Pavilion Frac Centre Orleans France—Pre-Assembly V1.0.” In Paradigms in Computing: Making, Machines, and Models for Design Agency in Architecture, by Marc Fornes, edited by David Jason Gerber and Mariana Ibañez, 186-91. Los Angeles: eVolo Press.
17. Thiemann, Robert. 2011. “Chroma Zones: From High to Low Tech and Back Again with SOFTlab.” Frame 7:92-99.
18. Shakeri, H., 2020. Rapid mold prototyping: creating complex 3D castables from 2D cuts (Doctoral dissertation, University of British Columbia).

What is claimed is:

1. A method for constructing at least a part of a mold for casting, the part comprising a freeform geometry, the method comprising the steps of:
a. digitally tessellating the freeform geometry of the mold into flat faces;
b. assigning the faces to unrollable segments of one or more faces;
c. digitally unrolling the segments;
d. digitally adjusting the unrolled segments to accommodate means of attaching them to their adjacent mold components, so that adjacent panels overlap, and so that fasteners connect adjacent panels through their area of overlap;
e. cutting the adjusted segments into panels out of flat sheet material; and
f. connecting the panels to each other.

2. The method of claim 1, wherein at least three of the segments contain three or more faces.

3. The method of claim 1, wherein at least five of the segments contain seven or more faces.

4. A method comprising constructing a mold according to claim 1, and casting concrete using said mold.

5. The method of claim 1, wherein the sheet material is a polymer.

6. The method of claim 1, wherein the panels are supported by a secondary frame.

7. The method of claim 1, wherein at least three of the segments contain three or more faces, wherein the sheet material is a polymer, wherein the panels are supported by a secondary frame, and using said mold for casting concrete.

8. The method of claim 1, wherein the sheet material is a metal.

9. The method of claim 1, wherein the sheet material is a metal, and wherein the freeform part of the mold is at least in part used as lost formwork.

10. The method of claim 1, wherein at least three of the segments contain three or more faces, wherein the sheet material is a metal, wherein the freeform part of the mold is at least in part used as lost formwork, and wherein the lost formwork at least in part acts to withstand at least some tensile forces within the manufactured object.

11. An article of manufacture, produced at least in part by casting, using a mold that comprises areas with a freeform geometry, the freeform areas of the mold constructed at least in part using a method comprising the steps of:
a. digitally tessellating the freeform geometry of the mold into flat faces;
b. assigning the faces to unrollable segments of one or more faces;
c. digitally unrolling the segments;
d. digitally adjusting the unrolled segments to accommodate means of attaching them to their adjacent mold components, so that adjacent panels overlap, and so that fasteners connect adjacent panels through their area of overlap;
e. cutting the adjusted segments into panels out of flat sheet material; and
f. connecting the panels to each other.

12. The article of manufacture of claim 11, wherein at least three of the segments contain three or more faces.

13. The article of manufacture of claim 11, wherein at least five of the segments contain seven or more faces.

14. The article of manufacture of claim 11, produced at least in part by casting concrete, wherein at least three of the segments contain three or more faces, wherein the sheet material is a polymer, and wherein the panels are supported by a secondary frame.

15. The article of manufacture of claim 11, produced at least in part by casting concrete, wherein at least three of the segments contain three or more faces, wherein the sheet material is a metal, and wherein the freeform part of the mold is at least in part used as lost formwork.

16. A mold for casting that comprises areas with a freeform geometry, the freeform areas of the mold constructed at least in part using a method comprising the steps of:
a. digitally tessellating the freeform geometry of the mold into flat faces;
b. assigning the faces to unrollable segments of one or more faces;
c. digitally unrolling the segments;
d. digitally adjusting the unrolled segments to accommodate means of attaching them to their adjacent mold components, so that adjacent panels overlap, and so that fasteners connect adjacent panels through their area of overlap;
e. cutting the adjusted segments into panels out of flat sheet material; and
f. connecting the panels to each other.

17. The mold for casting of claim 16, wherein at least three of the segments contain three or more faces.

18. The mold for casting of claim 16, wherein at least five of the segments contain seven or more faces.

19. The mold for casting of claim 16, wherein at least three of the segments contain three or more faces, wherein the sheet material is a polymer, wherein the panels are supported by a secondary frame, and using said mold for casting concrete.

20. The mold for casting of claim 16, wherein at least three of the segments contain three or more faces, wherein the sheet material is a metal, wherein the freeform part of the mold is at least in part used as lost formwork, and using said mold for casting concrete.
